(19) United States
(12) Patent Application Publication
(10) Pub. No.: US 2012/0193111 A1
(43) Pub. Date: Aug. 2, 2012

(54) SYSTEMS AND METHODS FOR PROVIDING A STAKE DRIVER ATTACHMENT APPARATUS

(76) Inventors: Ty Brent Lechtenberg, North Salt Lake, UT (US); Jonathan Layne, North Salt Lake, UT (US)

(21) Appl. No.: 13/359,268

(22) Filed: Jan. 26, 2012

Related U.S. Application Data
(60) Provisional application No. 61/438,876, filed on Feb. 2, 2011.

(51) Int. Cl. B25D 17/02; B25D 17/00

(52) U.S. Cl. 173/1; 173/90

(57) ABSTRACT

The invention relates to systems and methods for providing a stake driver attachment apparatus having a planar surface that facilitates driving a stake into a penetrable medium adjacent and substantially parallel to a stationary object or surface.

### CROSS-REFERENCE TO RELATED APPLICATIONS

This application claims the benefit of U.S. Provisional Application No. 61/438,876 filed Feb. 2, 2011, which is incorporated by reference herein in its entirety.

### BACKGROUND OF THE INVENTION

1. Field of the Invention

The present invention relates to stake driver systems and stake driver attachment apparatuses. In particular, the present invention relates to systems and methods for providing a stake driver attachment apparatus having a planar surface that facilitates driving a stake into a penetrable or semi-penetrable medium directly adjacent and substantially parallel to a stationary object or surface.

2. Background and Related Art

Stakes, rods, posts, markers and similar elongated elements are useful in accomplishing various tasks, such as identifying boundaries, temporarily or permanently retaining an object in a particular location, or grounding an electrical system. However, locating or placing such elongated elements, such as stakes, in a particular location is often a difficult task. For example, driving a stake into a penetrable or semi-penetrable medium, such as soil, can often be inhibited by densely compacted soil or rocks and roots beneath the surface of the soil. Accordingly, attempts have been made to develop manual or machine operated devices and/or systems adapted to facilitate the placement of elongated elements, such as stakes, into mediums that are difficult to penetrate. For example, hammer drills, jack hammers and similar external force applicators are frequently used in combination with attachments or adapters to facilitate mechanically driving elongated elements into particular locations.

However, current devices adapted to facilitate the placement of elongated elements are limited. For example, current attachments or adapters, that are designed to transfer the driving force from an external source to an elongated element, have structural components or features that interfere with the environment where the elongated element is to be placed. In particular, in some construction environments, such as concrete forming environments, it is desirable to temporarily secure concrete forms by the placement of stakes adjacent and substantially parallel to such forms. However, current adapters or attachment mechanisms include structural components that extend beyond each of the horizontal dimensions of the stake such that the use of such adapters prohibits locating the stake adjacent and substantially parallel to the forms. Rather, current devices require the stake to be driven at an angle relative to the form thereby inhibiting the efficacy and longevity of the stake placement.

Thus, while techniques currently exist that are used to facilitate driving or placing elongated elements into penetrable or semi-penetrable mediums, challenges still exist, including limitations on orientation and precision placement of the elongated element in addition to other desirable features. Accordingly, it would be an improvement in the art to augment or even replace current techniques with other techniques.

### SUMMARY OF THE INVENTION

The present invention relates to stake driver systems and stake driver attachment apparatuses. In particular, the present invention relates to systems and methods for providing a stake driver attachment apparatus having a planar surface that facilitates driving a stake into a penetrable or semi-penetrable medium directly adjacent and substantially parallel to a stationary object or surface.

Implementation of the present invention takes place in association with a stake driver attachment apparatus. In such implementations, the stake driver attachment apparatus includes an engagement head which defines or includes a central longitudinal axis. Further, such implementations of the stake driver attachment apparatus include a force transmitting body that is affixed distally to the engagement head along the central longitudinal axis defined by the engagement head. Such implementations further include a tubular sleeve that defines a longitudinal cavity passing through the tubular sleeve. In such implementations, the tubular sleeve is affixed distally to the force transmitting body along the central longitudinal axis discussed above. Moreover, in such implementations, the tubular sleeve is adapted to receive a terminal proximal end of a stake such that the terminal proximal end of the stake distally abuts the force transmitting body when the stake driver attachment apparatus is in use. In addition, such implementations of the stake driver attachment apparatus further include a planar surface that uniformly bisects both the force transmitting body and the tubular sleeve on one side of the central longitudinal axis discussed above. In this way, one side of the force transmitting body is flat and the longitudinal cavity defined by the tubular sleeve is exposed along one side of its longitudinal length.

Further implementations of the present invention take place in association with a stake driver system. In such implementations, the stake driver system includes an external force applicator, a stake driver attachment apparatus as discussed herein and one or more stakes configured to be driven by the interaction of the external force applicator and the stake driver attachment apparatus with the one or more stakes. In such implementations, the engagement head of the stake driver attachment apparatus is adapted to matably engage with corresponding components on the external force applicator.

Yet other implementations of the present invention take place in association with a method for driving a stake. In such implementations, the method includes the steps of providing an external force applicator, a stake driver attachment apparatus as discussed herein and one or more stakes configured to be driven by the interaction of the external force applicator and the stake driver attachment apparatus with the one or more stakes. Such implementations further include the steps of matably engaging the external force applicator with the stake driver attachment apparatus and temporarily connecting the stake driver attachment apparatus to each of the one or more stakes in turn. The method of such implementations is concluded as each of the one or more stakes are individually oriented adjacent and substantially parallel to a stationary object and driven into a penetrable medium while maintaining that orientation.

While the methods and processes of the present invention have proven to be particularly useful in the area of concrete form stake driver attachment apparatuses, those skilled in the art can appreciate that the methods and processes can be used in a variety of different applications and in a variety of different areas of manufacture to yield elongated element driver attachment or adapter apparatuses. By way of non-limiting example, the methods and processes disclosed herein can be used to yield enhanced devices and systems in the areas of driving or placing tent stakes, ground rods, fence posts, boundary markers and similar elongated elements.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a perspective view of a representative stake driver attachment apparatus in accordance with some embodiment of the present invention;

FIG. 2 illustrates a side view of a representative stake driver attachment apparatus in accordance with some embodiment of the present invention;

FIG. 3 illustrates a cross-sectioned view of the stake driver attachment apparatus of FIG. 2 taken along lines 3-3 of FIG. 2.

FIG. 4 illustrates a distal end view of the stake driver attachment apparatus of FIG. 2;

FIG. 5 illustrates a proximal end view of the stake driver attachment apparatus of FIG. 2;

FIG. 6 illustrates a perspective view of a representative stake driver attachment apparatus in accordance with some embodiment of the present invention;

FIG. 7 illustrates a side view of a representative stake driver attachment apparatus in accordance with some embodiment of the present invention;

FIG. 8 illustrates a cross-sectioned view of the stake driver attachment apparatus of FIG. 7 taken along lines 8-8 of FIG. 7.

FIG. 9 illustrates a distal end view of the stake driver attachment apparatus of FIG. 7;

FIG. 10 illustrates a proximal end view of the stake driver attachment apparatus of FIG. 7; and

FIG. 11 illustrates a flowchart of a method of driving a stake in accordance with some embodiment of the present invention.

### DETAILED DESCRIPTION OF THE INVENTION

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

The description may use perspective-based descriptions such as up/down, back/front, left/right and top/bottom. Such descriptions are merely used to facilitate the discussion and are not intended to restrict the application or embodiments of the present invention.

For the purposes of the present invention, the phrase “A/B” means A or B. For the purposes of the present invention, the phrase “A and/or B” means “(A), (B), or (A and B).” For the purposes of the present invention, the phrase “at least one of A, B, and C” means “(A), (B), (C), (A and B), (A and C), (B and C), or (A, B and C).”

Various operations may be described as multiple discrete operations in turn, in a manner that may be helpful in understanding embodiments of the present invention; however, the order of description should not be construed to imply that these operations are order dependent.

The description may use the phrases “in an embodiment,” or “in various embodiments,” which may each refer to one or more of the same or different embodiments. Furthermore, the terms “comprising,” “including,” “having,” and the like, as used with respect to embodiments of the present invention, are synonymous with the definition afforded the term “comprising.”

The present invention relates to stake driver systems and stake driver attachment apparatuses. In particular, the present invention relates to systems and methods for providing a stake driver attachment apparatus having a planar surface that facilitates driving a stake into a penetrable or semi-penetrable medium directly adjacent and substantially parallel to a stationary object or surface.

Embodiments of the present invention take place in association with a stake driver attachment apparatus. In such embodiments, the stake driver attachment apparatus includes an engagement head that defines a central longitudinal axis. Further, such embodiments of the stake driver attachment apparatus include a force transmitting body that is affixed distally to the engagement head along the central longitudinal axis defined by the engagement head. Such embodiments further include a tubular sleeve that defines a longitudinal cavity passing through the tubular sleeve. In such embodiments, the tubular sleeve is affixed distally to the force transmitting body along the central longitudinal axis discussed above. Moreover, in such embodiments, the tubular sleeve is adapted to receive a terminal proximal end of a stake such that the terminal proximal end of the stake distally abuts the force transmitting body when the stake driver attachment apparatus is in use. In addition, such embodiments of the stake driver attachment apparatus further include a planar surface that uniformly bisects both the force transmitting body and the tubular sleeve on one side of the central longitudinal axis discussed above. In this way, one side of the force transmitting body is flat and the longitudinal cavity defined by the tubular sleeve is exposed along one side of its longitudinal length.

Further embodiments of the present invention take place in association with a stake driver system. In such embodiments, the stake driver system includes an external force applicator, a stake driver attachment apparatus as discussed herein and one or more stakes configured to be driven by the interaction of the external force applicator and the stake driver attachment apparatus with the one or more stakes. In such embodiments, the engagement head of the stake driver attachment apparatus is adapted to matably engage with corresponding components on the external force applicator.

Yet other embodiments of the present invention take place in association with a method for driving a stake. In such embodiments, the method includes the steps of providing an external force applicator, a stake driver attachment apparatus as discussed herein and one or more stakes configured to be driven by the interaction of the external force applicator and the stake driver attachment apparatus with the one or more stakes. Such embodiments further include the steps of matably engaging the external force applicator with the stake driver attachment apparatus and temporarily connecting the stake driver attachment apparatus to a proximal terminal end of each of the one or more stakes in turn. The method of such embodiments is concluded as each of the one or more stakes are individually oriented adjacent and substantially parallel to a stationary object and driven into a penetrable medium while maintaining that orientation.

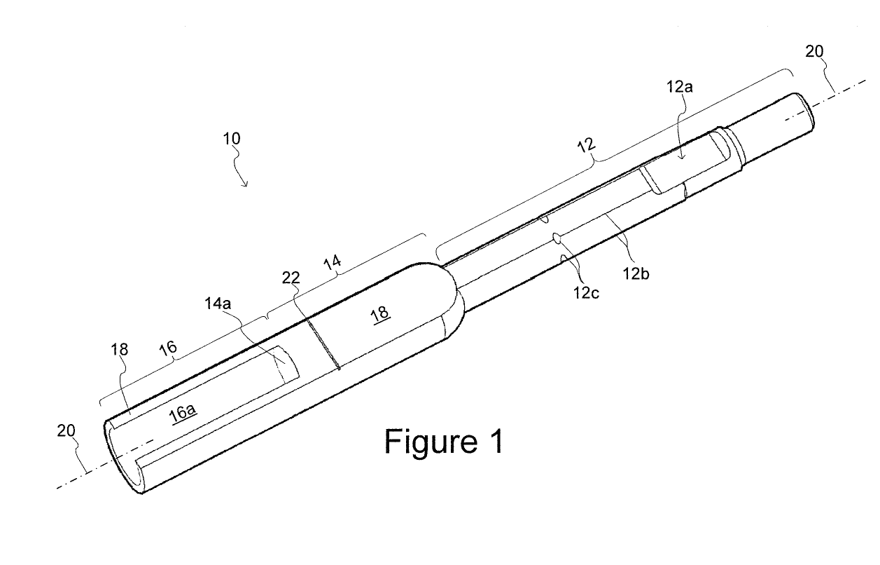

With reference now to FIG. 1, a perspective view of a representative stake driver attachment apparatus 10 is illustrated. As depicted in FIG. 1, some embodiments of stake driver attachment apparatus 10 include the following component features or elements: an engagement head 12, a force transmitting body 14, a tubular sleeve 16 and a planar surface 18. Each of the foregoing component elements, which are part of stake driver attachment apparatus 10 in some embodiments, will be discussed in greater detail below. Before turning to a discussion of the individual component elements referenced above, some embodiments of stake driver attachment apparatus 10 include component elements sharing common characteristics, such as the material such elements are made of or the method of manufacturing such elements. For convenience, such common characteristics will be discussed with reference to the constituent elements found in some embodiments of stake driver attachment apparatus 10 as a whole with the understanding that such is not intended to be limiting.

In some embodiments, stake driver attachment apparatus 10, including all of its component parts, is made from any desirable material with suitable properties and/or characteristics. By way of non-limiting example, in some embodiments stake driver attachment apparatus 10 is made of one or more of the following materials or combinations thereof: metallic materials, polymer materials, composite materials, synthetic materials, wood or fibrous materials, or resins. In such embodiments, the desirable or selected material is homogenous or uniform throughout while in other embodiments the selected material includes voids or encapsulates non-homogenous materials. In some embodiments, the material selected is dictated by the intended use of stake driver attachment apparatus 10. For example, in embodiments wherein stake driver attachment apparatus 10 is intended to endure significant and/or sustained loads or external forces, stake driver attachment apparatus 10 is constructed out of good load bearing and/or force transmitting materials, such as steel. In other embodiments, for example, wherein stake driver attachment apparatus 10 is intended to protect the striking surface of a stake against marring or deformation, stake driver attachment apparatus 10 is constructed out of rigid but semi-shock absorbent materials, such as polymer materials.

In some embodiments, stake driver attachment apparatus 10, including all of its constituent parts, are constructed out of the same material. For example, in some embodiments, engagement head 12, force transmitting body 14 and tubular sleeve 16 are all constructed out of the same material, such as metal, wood or plastic. In other embodiments, however, one or more constituent elements of stake driver attachment apparatus 10 is/are constructed out of a material that is different from the material of one or more of the remaining constituent elements of stake driver attachment apparatus 10. By way of non-limiting example, in some embodiments, engagement head 12 is constructed out of steel, force transmitting body 14 is constructed out of a polymer material and tubular sleeve 16 is constructed out of a composite material.

In addition, in some embodiments, stake driver attachment apparatus 10, including its component elements, is manufactured by any suitable method. By way of non-limiting example, in some embodiments, some or all of the component parts of stake driver attachment apparatus 10 is/are manufactured by one or more of the following methods: injection molding, rotational molding, casting and/or other molding processes, machining, cutting, carving, routing, punching, milling and/or other suitable forming or manufacturing processes. In some embodiments, each component part of stake driver attachment apparatus 10 is manufactured using the same method while in other embodiments one or more of the component parts of stake driver attachment apparatus 10 is/are manufactured using a method that is different from the method used to manufacture one or more of the remaining component parts of stake driver attachment apparatus 10.

Moreover, in some embodiments, the component parts of stake driver attachment apparatus 10 are manufactured separately and assembled to form stake driver attachment apparatus 10. In such embodiments, for example, the component parts of stake driver attachment apparatus 10 are fixed in relative position to one another on a permanent or semi-permanent basis by one or more of the following illustrative means: glue and/or other adhesives, ultrasonic welding, welding, nut and bolt combinations and other suitable methods known in the art for joining or retaining similar or dissimilar component parts together or in relative position to one another on a permanent or semi-permanent basis. In other embodiments, stake driver attachment apparatus 10 is integrally manufactured or formed as a single unit. In such embodiments, stake driver attachment apparatus 10 is either formed as a single unit, such as by casting or molding processes, or stake driver attachment apparatus 10 is formed from a solid homogenous stock material or solid core product, such as by machining or milling processes.

In some embodiments, the material selected for one or more of the component parts of stake driver attachment apparatus 10 dictates the suitable method of manufacture. For example, in embodiments wherein a component part of stake driver attachment apparatus 10 is manufactured out of steel, a casting or machining method of manufacture is used. As another example, in embodiments wherein a component part of stake driver attachment apparatus 10 is manufactured out of plastic, injection molding is an appropriate method of manufacturing such component part(s).

In addition, in some embodiments, the intended use of the stake driver attachment apparatus 10 dictates the suitable size of the one or more component parts. For example, in embodiments where the state driver attachment apparatus 10 is used to drive long stakes, the length of the elongated tube 16 and/or force transmitting body 14 can be relatively long. For instance, the elongated tube 16 or force transmitting body 14 can have a length between about one inch to about three inches, about three inches to about five inches, about five inches to about seven inches, about seven inches to about ten inches, about ten inches to about fifteen inches, or more than about fifteen inches. Similarly, the engagement body 12 can be sized to accommodate the intended uses. For instance, the engagement body 12 can have a length between about three inches to about five inches, about five inches to about seven inches, about seven inches to about ten inches, about ten inches to about fifteen inches, about fifteen inches to about twenty inches, about twenty inches to about twenty five inches, or more than about twenty five inches.

With reference to FIGS. 1 through 5, which depict various views of representative state driver attachment apparatuses 10, in some embodiments, stake driver attachment apparatus 10 includes engagement head 12 having a proximal end and a distal end. It should be noted that while terms like “proximal,” “distal,” “longitudinal,” “side” and so forth are used for convenience herein, such terms are intended solely to orient the reader with respect to the figures and are not intended to be limiting.

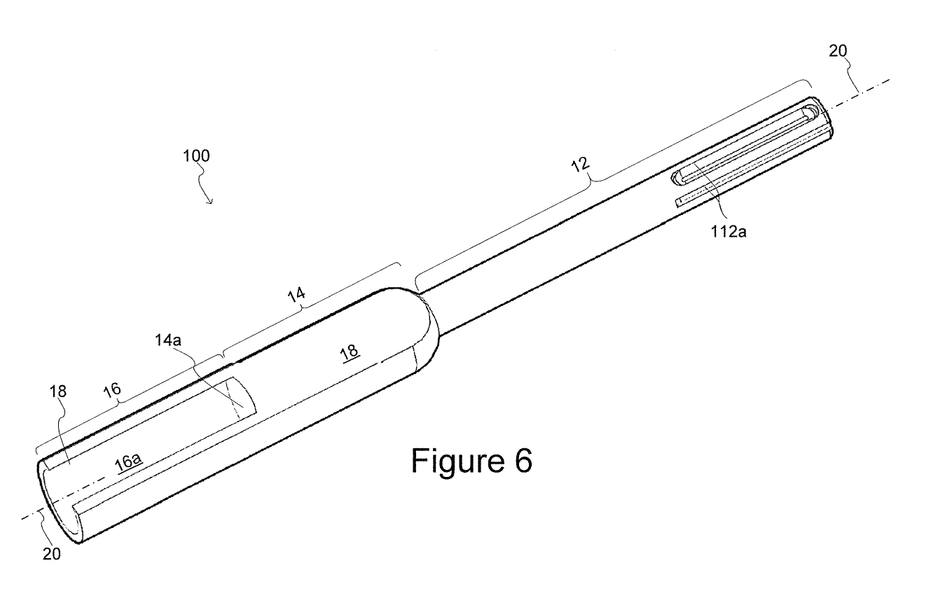

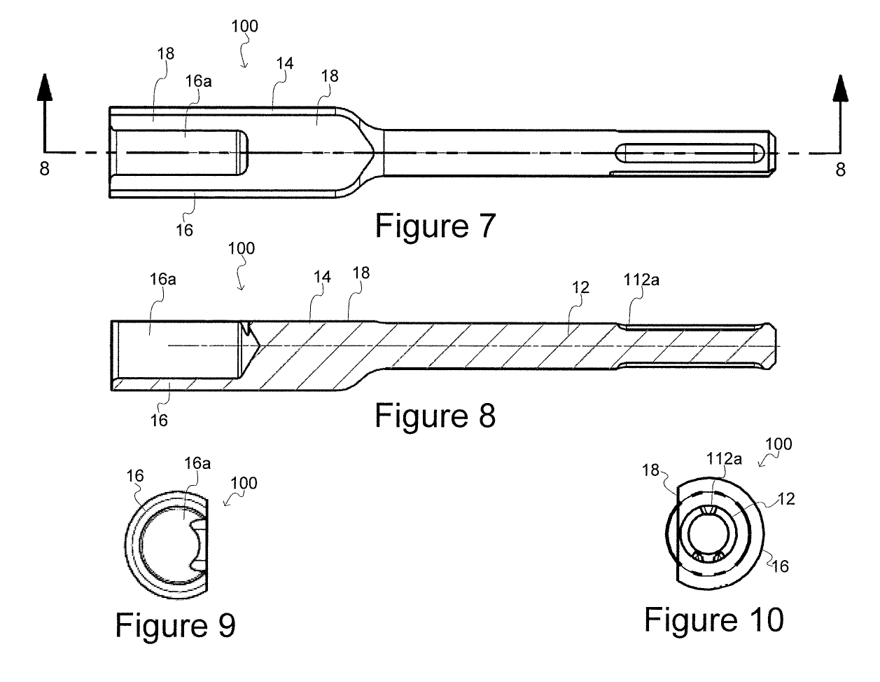

In some embodiments, engagement head 12 is configured for proximal mating engagement with an external device (not shown) such as a jack hammer, a hammer drill, and/or similar force applicators or sources known in the art. For example, in some embodiments, engagement head 12 has one or more recessed surfaces or faces 12a. In other embodiments, engagement head 12 includes a series of indentations, grooves, notches or dimples 12c. In yet other embodiments, engagement head 12 is formed having a hexagonal configuration 12b (clearly depicted in the FIG. 5) or other multi-sided geometric or polygonal configurations, such as triangular, square, pentagonal, heptagonal, star shaped and other such configurations, adapted for mechanical mating engagement with external devices known in the art. With brief reference to FIG. 6 through 10, which illustrate various other embodiments of a stake driver attachment apparatus, some embodiments of engagement head 112 include various formations 112a, such as slots, grooves, furrows, channels, guides, keyways, notches, indentations, protrusions (not shown), protuberances (not shown), bumps (not shown), knobs (not shown), bulges (not shown), lumps (not shown) and/or other formations adapted for mechanical mating engagement with external devices known in the art. In yet further embodiments, combinations of the features 12a, 12b, 12c and/or 112a, as identified by way of example above, are employed or formed at any desirable location on engagement head 12/112 in order to facilitate mechanical mating engagement with certain types of external devices known in the art such that rotational and/or axial forces can be transmitted from an external device/source through stake driver attachment apparatus 10/100.

Beyond the mating engagement features discussed above, engagement head 12/112 is formed having any dimensions, including width, depth, length, circumference, diameter and so forth suitable for mechanical mating engagement with external force applicators understood by those of skill in the art. While engagement head 12/112 is substantially cylindrical in some embodiments (e.g., FIG. 6), in other embodiments, engagement head 12/112 is any suitable shape, such as triangular, square, pentagonal, hexagonal (see FIG. 1), heptagonal or any other geometrical or polygonal shape.

As mentioned briefly above, in some embodiments, engagement head 12/112 defines a central longitudinal axis 20 commonly shared by all of the component elements of stake driver attachment apparatus 10/100.

With continued reference to FIGS. 1 through 5, in some embodiments, stake driver attachment apparatus 10 includes force transmitting body 14 having a proximal end and a distal end. As depicted in FIG. 1, in some embodiments, the proximal end of force transmitting body 14 is longitudinally affixed to the distal end of engagement head 12 along the central longitudinal axis 20. As discussed above, in some embodiments, the junction between the distal end of engagement head 12 and the proximal end of force transmitting body 14 is integral while in other embodiments engagement head 12 and force transmitting body 14 are affixed to one another by suitable attachment means, such as welding, nut and bolt combinations, and the like. In some embodiments, the distal end of force transmitting body 14 is adapted to abut a terminal proximal end of a stake (not shown) during use of stake driver attachment apparatus 10. In this manner, force that is produced by an external source (not shown) and transmitted via engagement head 12 as discussed above, is further transmitted relative to the stake such that the stake is driven by such force into a penetrable or semi-penetrable medium or substance (not shown).

In some embodiments, the distal surface 14a of force transmitting body 14 is configured to accommodate the terminal proximal end of the stake. By way of non-limiting example, in such embodiments, distal surface 14a is one of concave, convex, square, chamfered, filleted, triangular, domed, rounded, or flat. In other embodiments, distal surface 14a is configured for matable engagement with the terminal proximal end of the stake. By way of non-limiting example, in such embodiments, distal surface 14a is equipped with gripping means, such as teeth, tines, spikes and other gripping surfaces. Alternatively, distal surface 14a is recessed having a suitable geometric or polygonal shape, such as triangular, square, pentagonal, hexagonal, star shaped and so forth.

In some embodiments, force transmitting body 14 includes additional features, such as marks or measurements 22 and other aesthetic features to facilitate use of stake driver attachment apparatus 10. In other embodiments, element 22 is structural.

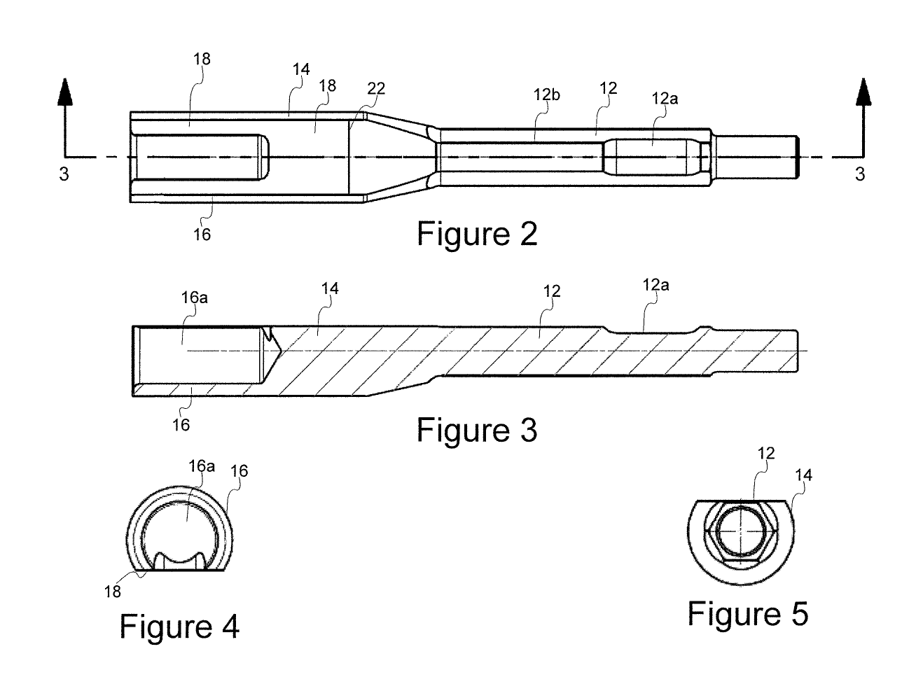

As with engagement head 12, in some embodiments force transmitting body 14 is formed having any dimensions, including width, depth, length, circumference, diameter and so forth. Further, while force transmitting body 14 is substantially cylindrical in some embodiments (e.g., FIGS. 1 and 2), in other embodiments, force transmitting body 14 is any suitable shape, such as triangular, square, pentagonal, hexagonal, heptagonal or any other geometric or polygonal shape.

With continued reference to FIGS. 1 through 10, in some embodiments, stake driver attachment apparatus 10 includes tubular sleeve 16 having a proximal end and a distal end. As depicted, in some embodiments, the proximal end of tubular sleeve 16 is longitudinally affixed to the distal end of force transmitting body 14 along the central longitudinal axis 20. As discussed above, in some embodiments, the junction between the distal end of force transmitting body 14 and the proximal end of tubular sleeve 16 is integral while in other embodiments force transmitting body 14 and tubular sleeve 16 are affixed to one another by suitable attachment means, such as welding, nut and bolt combinations, and the like.

In some embodiments, tubular sleeve 16 defines a longitudinal cavity 16a that extends through the entire length of tubular sleeve 16. In some embodiments, tubular sleeve 16 is adapted to slidably receive the terminal proximal end of a stake (not shown) such that the terminal proximal end of the stake abuts the distal surface of force transmitting body 14 during use of stake driver attachment apparatus 10 as discussed above. In such embodiments, tubular sleeve 16 surrounds at least a portion of the stake so as to provide lateral support for the stake while the stake is driven by means of stake driver attachment apparatus 10 in conjunction with an external force producing source. In other embodiments, cavity 16a is adapted to mechanically engage the stake, such by threading, slots, keyways, and similar mechanical engagement means such that rotational force can be transmitted to the stake via tubular sleeve 16. In all such embodiments, tubular sleeve 16 and longitudinal cavity 16a are shaped and adapted to accommodate the appropriate shape, size and style of the stake to be received thereby. The longitudinal cavity 16a can have various sized openings. For instance, the opening can have a maximum length of about one-half inch to about one inch, about one inch to about two inches, about two inches to about three inches, or more than about three inches.

As above, in some embodiments tubular sleeve 16 is formed having any dimensions, including width, depth, length, circumference, diameter and so forth. In some embodiments, some dimensions are dictated by design requirements. For example, in embodiments adapted to drive longer stakes, tubular sleeve 16 is longer to provide enhanced lateral support for the stake during the driving process. Further, while tubular sleeve 16 is substantially cylindrical in some embodiments (e.g., FIGS. 1 and 6), in other embodiments, tubular sleeve 16 is any suitable shape, such as triangular, square, pentagonal, hexagonal, heptagonal, star shaped or any other geometric or polygonal shape. Accordingly, by way of non-limiting example, in some embodiments, as depicted in FIG. 4, the combination of tubular sleeve 16 and longitudinal cavity 16a forms a torus or annulus defined by concentric circles. However, in other embodiments, the cross-section of tubular sleeve 16 and longitudinal cavity 16a forms a square, or any other desirable geometric or polygonal shape, having a particular thickness on one or more of its sides.

As mentioned briefly above, and with continued reference to FIGS. 1 through 10, some embodiments of stake driver attachment apparatus 10 include planar surface 18/118. In such embodiments, planar surface 18/118 uniformly bisects both tubular sleeve 16 and force transmitting body 14. Further, in such embodiments, planar surface 18/118 bisects elements 14 and 16 entirely on one side of central longitudinal axis 20/120. In this way, force transmitting body 14 has at least one substantially flat surface defined by planar surface 18. Moreover, at least a portion of the planar surface 18/118 can extend parallel to the central longitudinal axis 20/120. Further, in some embodiments, the planar surface 18 is coplanar with at least one portion of the engagement head. As shown, the planar surface 18 can be positioned away from the central longitudinal axis 20/120 at a distance such that one side of longitudinal cavity 16a is exposed along its longitudinal length at the bisection of tubular sleeve 16 and planar surface 18. Planar surface 18 permits elongated elements, such as stakes, to be driven into a penetrable or semi-penetrable medium while continuously oriented directly adjacent and substantially parallel to a stationary object or surface. In some embodiments, the stake (not shown) horizontally extends beyond planar surface 18/118 when received by tubular sleeve 16 such that the stake can be driven into place while continuously maintaining physical contact with the stationary object or surface which it is intended to support.

In some embodiments, planar surface 18/118 is any desirable distance between central longitudinal axis 20/120 and the outer dimension of element(s) 14 and/or 16 so long as planar surface 18/118 does not interfere with the stake driving environment, such as a stationary object the stake is intended to support, when stake driver attachment apparatus 10 is in use. In embodiments contemplating a cylindrical tubular sleeve 16, as depicted in the FIGS. 4 and 9, the bisection of tubular sleeve 16 and planar surface 18 (located entirely on one side of central longitudinal axis 20) results in a cross-section of tubular sleeve 16 defining a major arc. In other words, such a cross-section has a measure greater than a semi-circle or 180 degrees but less than a full circle or 360 degrees. In this way, tubular sleeve 16 will not interfere with the driving environment but will maintain adequate lateral support for the stake being driven during the driving process. In other embodiments, for example, the cross-section of tubular sleeve 16 forms a square bounded on three sides such that the stake is laterally supported by tubular sleeve 16 on three sides and laterally supported by the driving environment on the fourth side.

As referenced throughout this disclosure, embodiments of the present invention contemplate stake driver systems (not shown). In such embodiments, the stake driver system includes an external force applicator known in the art (not shown), stake driver attachment apparatus 10 as discussed in detail above with reference to FIGS. 1 through 10, and one or more stakes (not shown) configured to be driven by the interaction of the external force applicator and stake driver attachment apparatus 10 with the one or more stakes.

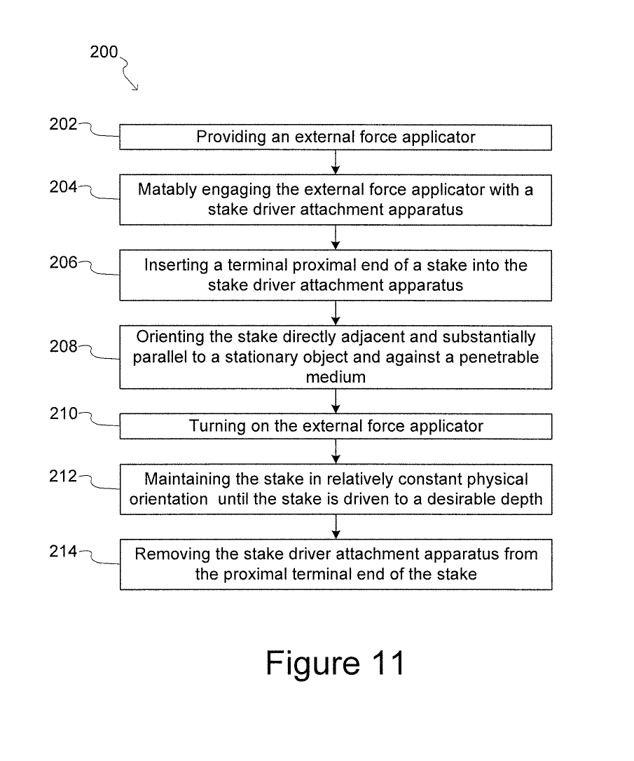

Moreover, as shown in FIG. 11, embodiments of the present invention further contemplate a method 200 for driving an elongated element, such as a stake, into a penetrable or semi-penetrable medium. As shown, in step 202, an external force applicator is provided. Furthermore, a stake driver attachment apparatus and one or more stakes may also be provided. In step 204, the external force applicator is matably engaged with the stake driver attachment apparatus. In step 206, a terminal proximal end of each of the one or more stakes in turn inserted into the tubular sleeve of the stake driver attachment apparatus. In step 208, each of the one or more stakes is oriented directly adjacent and substantially parallel to a stationary object and against a penetrable medium. In step 210, the external force applicator is turned on and produces forces that are transferred via stake driver attachment apparatus to drive the stake into the penetrable medium. In step 212, the stake driver attachment is maintained in relatively constant physical orientation of the stake until the stake is driven to a desirable depth. Lastly, in step 214, the stake driver attachment apparatus is removed from the proximal terminal end of the stake. In this way, elongated elements are capable of being driven directly adjacent and substantially parallel to an object or surface against which the elongated element is intended to abut. This process can be repeated to drive additional stakes into the penetrable medium.

Thus, as discussed herein, embodiments of the present invention embrace elongated element driver attachment systems, devices and methods.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A stake driver attachment apparatus, comprising:
an engagement head having a central longitudinal axis;
a force transmitting body affixed distally to the engagement head along the central longitudinal axis;
a tubular sleeve defining a longitudinal cavity therethrough, wherein the tubular sleeve is affixed distally to the force transmitting body along the central longitudinal axis, and wherein the tubular sleeve is adapted to receive a terminal proximal end of a stake such that a terminal proximal end of a stake distally abuts a distal end of the force transmitting body during use; and
a planar surface, wherein the planar surface uniformly bisects the force transmitting body and the tubular sleeve on one side of the central longitudinal axis such that the force transmitting body has a flat side and the longitudinal cavity is exposed along one side.

2. The stake driver attachment apparatus of claim 1, wherein a portion of the planar surface runs parallel to the central longitudinal axis.

3. The stake driver attachment apparatus of claim 1, wherein a portion of the planar surface is coplanar with a portion of the engagement head.

4. The stake driver attachment apparatus of claim 1, wherein the tubular sleeve is between about one inch to about six inches in length.

5. The stake driver attachment apparatus of claim 3, wherein the tubular sleeve is about three inches in length.

6. The stake driver attachment apparatus of claim 3, wherein the force transmitting body is between about one inch and about five inches in length.

7. The stake driver attachment apparatus of claim 5, wherein the engagement head is between about three inches to about twelve inches.

8. The stake driver attachment apparatus of claim 1, wherein the engagement head includes one or more recessed surface.

9. The stake driver attachment apparatus of claim 1, wherein the engagement head includes a plurality of grooves.

10. The stake driver attachment apparatus of claim 1, wherein the longitudinal cavity has an approximately circular cross section.

11. The stake driver attachment apparatus of claim 1, wherein the distal end of the force transmitting body is concave.

12. A stake driver system, comprising:
an external force applicator;
an engagement head defining a central longitudinal axis, the engagement head being coupled to the external force applicator;
a force transmitting body affixed distally to the engagement head along the central longitudinal axis;
a tubular sleeve defining a longitudinal cavity therethrough, wherein the tubular sleeve is affixed distally to the force transmitting body along the central longitudinal axis, and wherein the tubular sleeve is adapted to receive a terminal proximal end of a stake such that a terminal proximal end of a stake distally abuts the force transmitting body during use; and
a planar surface, wherein the planar surface uniformly bisects the force transmitting body and the tubular sleeve on one side of the central longitudinal axis such that the force transmitting body has a flat side and the longitudinal cavity is exposed along one side.

13. The stake driver system of claim 12, wherein a portion of the planar surface runs parallel to the central longitudinal axis.

14. The stake driver system of claim 13, wherein the tubular sleeve is between about one inch to about six inches in length, the force transmitting body is between about one inch and about five inches in length, and the engagement head is between about three inches to about twelve inches.

15. The stake driver system of claim 15, wherein the engagement head includes one or more recessed surface or a plurality of grooves.

16. The stake driver system of claim 12, wherein a portion of the planar surface is coplanar with a portion of the engagement head.

17. The stake driver system of claim 12, wherein the longitudinal cavity has an approximately circular cross section.

18. The stake driver system of claim 12, wherein the distal end of the force transmitting body is concave.

19. A method for driving a stake, the method comprising:
providing an external force applicator;
matably engaging the external force applicator with the stake driver attachment apparatus, the stake driver apparatus having a tubular sleeve defining a longitudinal cavity therethrough, the tubular sleeve having a planar surface that uniformly bisects the tubular sleeve on one side of the central longitudinal axis such that the longitudinal cavity is exposed along one side;
inserting a terminal proximal end of a stake into the tubular sleeve;
placing the planar surface of the stake driver attachment apparatus in contact with a stationary object oriented parallel to the planar surface; and
driving the stake into a penetrable medium such that the stake is adjacent and substantially parallel to the stationary object.

20. The method of claim 19, wherein the stake driver attachment apparatus further includes an engagement head defining a central longitudinal axis, the engagement head being coupled to the external force applicator, a force transmitting body being affixed distally to the engagement head along the central longitudinal axis, and the tubular sleeve being affixed distally to the force transmitting body along the central longitudinal axis.
